(19) United States
(12) Patent Application Publication
(10) Pub. No.: US 2015/0312024 A1
(43) Pub. Date: Oct. 29, 2015

(54) COMPUTER PROGRAM PRODUCTS, MODULES AND METHOD TO GENERATE INTEGER ZERO AUTOCORRELATION SEQUENCE

(71) Applicant: Chunghwa Telecom Co., Ltd., Yangmei City (TW)

(72) Inventor: Kuo-Wei Chang, Yangmei City (TW)

(21) Appl. No.: 14/500,180

(22) Filed: Sep. 29, 2014

(30) Foreign Application Priority Data
Apr. 25, 2014 (TW) 103114926

(51) Int. Cl. H04L 7/04; H04L 7/00

(52) U.S. Cl. CPC H04L 7/042; H04L 7/007

(57) ABSTRACT

The present application provides a method, a module, and a computer program product to generating a zero autocorrelation sequence with all integer values in the sequence. When a user operates communication transmission, the present application is applied to generate a sequence with integer values for synchronization, which is able to make control signal and data transmission synchronized.

### BACKGROUND

1. Field of the Invention

The present application relates to a method, a module, and a computer program product to generate integer zero autocorrelation sequence. In a communication protocol, it is usual to transmit a particular preamble in each frame start position as a reference signal for data synchronization, establishing system synchronization, and other communication initialization operations. It is conventional to apply peak values of auto-correlation function for synchronization by calculating auto-correlation function of the preamble in conventional communication protocols. To achieve precise synchronization, the preamble would be designed for resulting in only peak value exists but other auto-correlation values are zero, which is so-called a zero autocorrelation sequence. The present application is able to generate a zero autocorrelation sequence with all integer values in the sequence.

2. Description of the Prior Art

Recently, the zero autocorrelation sequence receives more and more attention. Previously, Zadoff-Chu sequences, which were provided in US2009116587 A1, WO 2010011863 A1 and Chinese Patent No. CN 102105859 A, require a floating point operation for approximation calculation. Recently, a method of generating Gaussian integer sequences, which avoids the floating point operation and approximation calculation. However, a Gaussian integer has two integer sequences including a real part and an imaginary part, and it takes a double storage space comparing with the general integer sequences. Moreover, a presumption of whether the length of the sequence is an even number or a prime number has to be determined in advance, which is not convenient in use.

### SUMMARY OF THE APPLICATION

The above proves that the aforementioned prior art is still faulty in many aspects, which is not a well-found design and remains to be improved. To provide a sequence with all integer values in the sequence and zero autocorrelation, the inventor aims at technical development to solve the aforementioned conventional issues. After years of development, the inventor provides a method, a module, and a computer program product to generate integer zero autocorrelation sequence of the present application.

One objective of the present application is to provide a method to generate a zero autocorrelation sequence with all integer values in the sequence. More particularly, the present application can be applied in signal synchronization in communication system.

The method to generate a zero autocorrelation sequence with all integer values in the sequence of the present application comprises steps of fast generating low correlation sequence with integer values by applying factor analysis information of a sequence with a length N. According to the present application, before outputting the sequence with integer values, it operates common factor sequence calculation to reduce the autocorrelation to zero. Then a Fourier transform is operated and a sequence is generated. According to the present application, to get different sequences quickly, methods of cyclic shifting and/or multiplying positive/negative unit can be applied.

Another objective of the present application is to provide a computer program product of a stored program. When a computer loads and runs the program, the computer is able to operate the aforementioned method to generate a zero autocorrelation sequence with all integer values in the sequence.

The method of the present application comprises: inputting sequence with a length of N, retrieving all factor information by using a factor analysis module; calculating and getting all common factor sequences by applying the information in a common factor sequence generation module; retrieving factor periodic sequence by Fourier transformation, and it is noted that the Fourier transformation of the common factor sequence is a sequence with integer values, which means that the factor periodic sequence must be a sequence with integer values; finally, processing all factor periodic sequences by cyclic shifting, multiplying by a positive/negative unit, and summing all the processed sequences up to get a zero autocorrelation sequence with all integer values in the sequence. It is noted that every factor periodic sequence has to be applied, or the autocorrelation could not be zero.

A module to generate a zero autocorrelation sequence with all integer values in the sequence is provided, which comprises: a length input unit, being configured to get a length N by an external interface; a calculation unit, being configured to calculate factor analysis and linear summation; a Fourier transformation unit, being configured to perform Fourier transformation; a temporary storage unit, being configured to temporarily store the sequences and perform cyclic shift; and a sequence outputting unit, being configured to output the zero autocorrelation sequence with all integer values in the sequence to the external interface.

### BRIEF DESCRIPTION OF THE DRAWINGS

Detailed specification and corresponding figures are provided in understanding the technologies and features of the present application.

FIG. 1 shows a computer program product according to an embodiment of the present application;

FIG. 2 shows a module for generating a zero autocorrelation sequence with all integer values in the sequence; and

FIG. 3 shows a flow chart of a method to generate a zero autocorrelation sequence with all integer values in the sequence.

### DETAILED DESCRIPTION OF THE EMBODIMENT

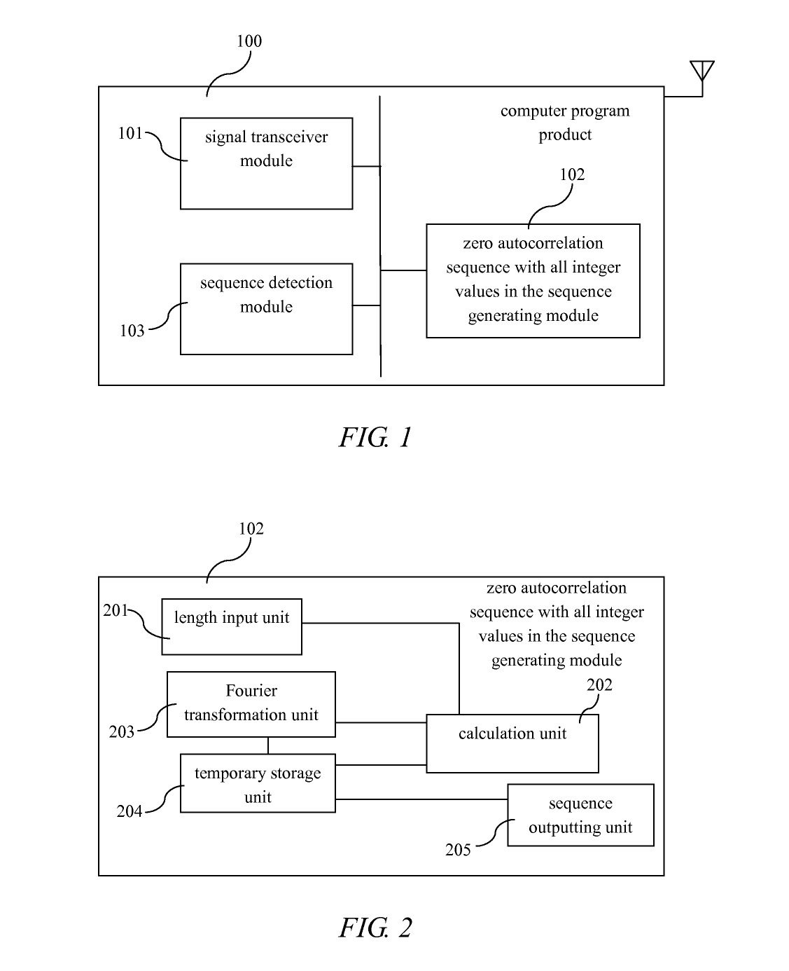

FIG. 1 shows a computer program product 100, which comprises a signal transceiver module 101, a zero autocorrelation sequence with all integer values in the sequence generating module 102, and a sequence detection module 103.

Assuming a certain person a wants to communicate with a certain person b by the computer program product 100, the certain person a can run the zero autocorrelation sequence with all integer values in the sequence generating module 102 to generate a sequence, then run the signal transceiver module 101 to transmit the sequence first, and then transmits the message to the certain person b.

FIG. 2 shows a module for generating a zero autocorrelation sequence with all integer values in the sequence of the present application. It comprises a length input unit 201, being configured to get a length N by an external interface; a calculation unit 202, being configured to calculate factor analysis and linear summation; a Fourier transformation unit 203, being configured to performed Fourier transformation; a temporary storage unit 204, being configured to temporarily store the sequences and perform cyclic shift; and a sequence outputting unit 205, being configured to output the sequence.

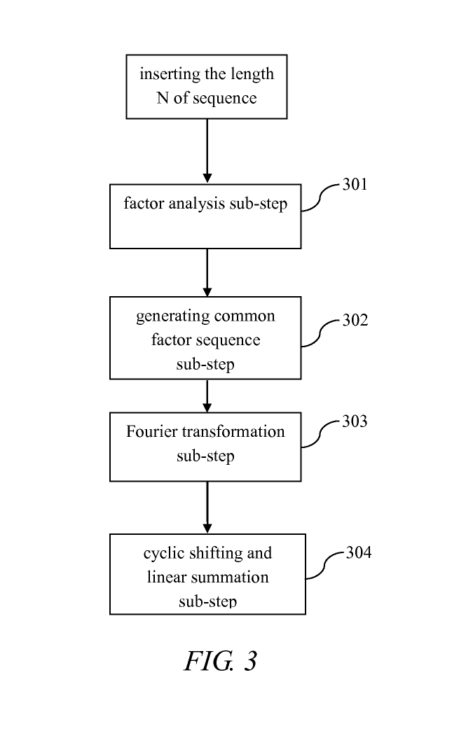

FIG. 3 shows a flow chart of a method to generate a zero autocorrelation sequence with all integer values in the sequence of the present application.
1. assuming the length of the desired sequence is 12, which means that N=12, and the factor analysis sub-step 301 is executed to obtain 6 factors of N of d={1,2, 3, 4, 6, 12 }.
2. generating common factor sequence sub-step 302 is executed to generate s_{N,d}(n) as shown below:

s_{12,1}(n)={0,1,0,0,0,1,0,1,0,0,0,1}

s_{12,2}(n)={0,0,1,0,0,0,0,0,0,0,1,0}

s_{12,3}(n)={0,0,0,1,0,0,0,0,0,1,0,0}

s_{12,4}(n)={0,0,0,0,1,0,0,0,1,0,0,0}

s_{12,6}(n)={0,0,0,0,0,0,1,0,0,0,0,0}

s_{12,12}(n)={1,0,0,0,0,0,0,0,0,0,0,0}

More particularly, the generating common factor sequence sub-step assumes that if the greatest common divisor between n and 12 is d, then s_{12,d}(n)=1; otherwise s_{12,d}(n)=0, wherein n={0,1,2, •••,11}.
3. Fourier transformation sub-step 303 is executed to transform the aforementioned 6 sequences in to factor periodic sequence as shown below:

S_{12,1}(n)={4,0,2,0,-2,0,-4,0,-2,0,2,0}

S_{12,2}(n)={2,1,-1,-2,-1,1,2,1,-1,-2,-1,1}

S_{12,3}(n)={2,0,-2,0,2,0,-2,0,2,0,-2,0}

S_{12,4}(n)={2,-1,-1,2,-1,-1,2,-1,-1,2,-1,-1}

S_{12,6}(n)={1,-1,1,-1,1,-1,1,-1,1,-1,1,-1}

S_{12,12}(n)={1,1,1,1,1,1,1,1,1,1,1,1}

4. cyclic shifting and linear summation sub-step 304 is executed to do cyclic shifting and multiplication of a positive/negative unit on the aforementioned factor periodic sequence, wherein the shift of each factor periodic sequence can be different or the same, and the multiplication of the positive/negative unit of each factor periodic sequence can be different or the same.

Example 4-1: S_{12,1}(n) spins with 2 position shift, and the negative unit is multiplied, meanwhile the rest does not spin and is multiplied by the positive unit to get result as below:

G(n)={2,0,4,0,2,0,−2,0,−4,0,−2,0}×(−1)+

{2,1,−1,−2,−1,1,2,1,−1,−2,−1,1}+

{2,0,−2,0,2,0,−2,0,2,0,−2,0}+

{2,−1,−1,2,−1,−1,2,−1,−1,2,−1,−1}+

{1,−1,1,−1,1,−1,1,−1,1,−1,1,−1 }+

{1,1,1,1,1,1,1,1,1,1,1,1}={6, 0,−6,0,0,0,6,0,6,0,0,0}

This is a 12 integers sequence and the autocorrelation is zero.

Example 4-2: S_{12,1}(n) spins with 2 position shift, and the negative unit is multiplied, S_{12,2}(n) spins with 1 position shift, and the positive unit is multiplied, meanwhile the rest does not spin and is multiplied by the positive unit to get another integer sequence with zero autocorrelation as below:

G(n)={2,0,4,0,2,0,−2,0,−4,0,−2,0}×(−1)+

{1,2,1,−1,−2,−1,1,2,1,−1,−2,−1}+

{2,0,−2,0,2,0,−2,0,2,0,−2,0}+

{2,−1,−1,2,−1,−1,2,−1,−1,2,−1,−1}+

{1,−1,1,−1,1,−1,1,−1,1,−1,1,−1}+

{1,1,1,1,1,1,1,1,1,1,1,1}={5,1,−4,1,−1,−2,5,1,8,1,−1,−2}

Referring to FIG. 1, when the computer program product 100 of the certain person b receives the sequence and the message from the certain person a by the signal transceiver module 101, the sequence detection module 103 can be applied to detect the autocorrelation. By detecting autocorrelation values, it is able to know the synchronization or delay information as well as know the message from the certain person a. For example, assuming the certain person b received message as below:

{3,7,3,4, 5,1,−4,1,−1,−2,5,1,8,1,−1,−2,2,4,6,−7,••••••}

By detecting the autocorrelation of the sequence by the sequence detection module 103, it is known that the autocorrelation is zero corresponding to the integer with underline in the sequence. Thus, it is known that he message behind the integer with underline in the sequence and {2,4,6,−7,•••} are the message from the certain person a, and the {3,7,3,4} in the beginning of the sequence is not the message from the certain person a.

The present application provides a method, a module, and a computer program product to generating a zero autocorrelation sequence with all integer values in the sequence, which has advantages as below when comparing with the conventional technologies.
1. The present application is able to generate sequences with zero autocorrelation in arbitrary length;
2. In the sequence with zero autocorrelation generated by the present application, each number within the sequence is an integer, which is convenient in later calculation and storage applications.

Many changes and modifications in the above described embodiment of the application can, of course, be carried out without departing from the scope thereof Accordingly, to promote the progress in science and the useful arts, the application is disclosed and is intended to be limited only by the scope of the appended claims.

1. A method to generate a zero autocorrelation sequence with all integer values in the sequence for determining a message source of a signal transmission, comprising:
receiving a signal containing a preamble with a length N via a length input unit;
performing factor analysis to generate factors of N of a sequence length;
generating common factor sequences of all factors;
performing Fourier transformation to transform the common factor sequences into factor periodic sequences;
performing cyclic shifting and linear summation, selecting and summing up spin and a positive/negative unit to obtain the zero autocorrelation sequence with all integer values in the sequence; and
determining the message source of the signal transmission by using the obtained zero autocorrelation sequence, wherein
generating the common factor sequences of all factors is to derive common factor sequences sN,d(n) based on all factors d of N, and
the method further comprises generating common factor sequences of all factors comprises setting sN,d(n)=1 where the greatest common divisor is d among n and N for n={0,1,2, . . . ,N−1} otherwise sN,d(n)=0.

2. (canceled)

3. The method to generating a zero autocorrelation sequence with all integer values in the sequence as claimed in claim 1, wherein performing cyclic shifting and linear summation is to perform cyclic shifting and multiplication of the positive/negative unit on all factor periodic sequences, wherein the shifting of each factor periodic sequence is either different or the same, and the multiplication of the positive/negative unit of each factor periodic sequence is either different or the same, and by summing up all the processed sequences, the zero autocorrelation sequence with all integer values in the sequence is generated.

4. A zero autocorrelation sequence device that generates a zero autocorrelation sequence with all integer values in the sequence is provided, comprising:
a processor; and
a memory that stores a computer program, wherein
when the computer program is executed, the processor function as:
a length input unit, being configured to get a length N by an external interface;
a calculation unit, being configured to calculate factor analysis and linear summation and to perform common factor sequences of all factors to derive common factor sequences sN,d(n) based on all factors d of N;
a Fourier transformation unit, being configured to perform Fourier transformation;
a temporary storage unit, being configured to temporarily store the sequences and perform cyclic shift;
a sequence outputting unit, being configured to output the zero autocorrelation sequence with all integer values in the sequence to the external interface; and
a sequence detection module, being configured to determining a message source of a signal transmission by using the obtained zero autocorrelation sequence, wherein
to perform the common factor sequences, the calculation unit sets sN,d(n)=1 where the greatest common divisor d among n and N for n={0,1,2, . . . ,N−1} , otherwise sN,d(n)=0.

5. (canceled)
